(19) United States
(12) Patent Application Publication
(10) Pub. No.: US 2007/0039415 A1
(43) Pub. Date: Feb. 22, 2007

(54) Rotary indexing table

(75) Inventor: Uwe Weiss, Buchen (DE)

Correspondence Address: GIFFORD, KRASS, GROH, SPRINKLE & CITKOWSKI, P.C, PO BOX 7021, TROY, MI, 48007-7021, US

(73) Assignee: Weiss GmbH Sondermaschinentechnik, Buchen (DE)

(21) Appl. No.: 11/498,698

(22) Filed: Aug. 3, 2006

(30) Foreign Application Priority Data
Aug. 16, 2005 (DE) 10 2005 038 663.6

(51) Int. Cl. B23B 29/24

(52) U.S. Cl. 74/814

(57) ABSTRACT

The invention relates to a rotary indexing table comprising a turntable which has drivers engaging into a barrel cam, with the turntable being rotatably drivable relative to a stationary center part via the barrel cam which can in turn be acted on by a motor via at least one force transmission element to make a rotary movement around its longitudinal axis. In this connection a sensor generating an output signal and reacting to pressure and/or tension is provided in the region of the barrel cam and/or in the region of a force transmission element and/or in the region of the drivers; wherein an evaluation unit is furthermore provided for the output of a motor stopping signal when the output signal exceeds a threshold value.

### CROSS-REFERENCE TO RELATED APPLICATIONS

This application claims the benefit of German Patent Application No. 10 2005 038 663.6, filed on Aug. 16, 2005. The disclosure of the above application is incorporated herein by reference.

### FIELD OF THE INVENTION

The invention relates to a rotary indexing table comprising a turntable which has drivers which engage into a barrel cam, with the turntable being rotatably drivable via the barrel cam relative to a stationary center part which can in turn be acted on by a motor via at least one force transmission element to make a rotary movement around its longitudinal axis.

### BACKGROUND OF THE INVENTION

Rotary indexing tables of this type such as are known in different embodiments from the prior art serve, for example, to further transport workpieces held on the said turntable or on structures arranged thereon in each case by a rotation of the turntable from one machining or assembly station to a next machining or assembly station. This transport typically takes place within the framework of a cycle operation in which the turntable is rotated with each cycle by an angular dimension which can correspond, for example, to the angular spacing between two adjacent workpieces located on the turntable.

It is desirable on the carrying out of each rotary cycle for the rotary movement of the turntable to take place such that a speed development free of jerks and jolts of the workpieces located on the turntable is ensured, which means that the acceleration of the rotary movement of the turntable only increases slowly at the start of a cycle and then increases faster, whereupon it first faster, and then more slowly, approaches the value of zero again. The development of acceleration of the turntable during a cycle preferably approximately corresponds to a sine wave.

During the practical use of rotary indexing tables of the described type, it occurs that the rotary movement of the turntable is blocked in an unintentional manner, for example by external machining stations. In this case, the drive of the turntable must then be interrupted as fast as possible to avoid damage to workpieces, to parts of the turntable drive or to the turntable itself.

To achieve this, it is e.g. known in accordance with the prior art to provide an overload coupling directly at the turntable which can be realized, for example, by a disk arranged beneath the turntable which only has a latch connection to the turntable, but is fixedly connected to the actual turntable drive. If a blocking of the turntable occurs in a constellation of this type, the latch connection between the disk and the turntable is released, which has the consequence that the disk can continue to be driven by the turntable drive without the turntable itself rotating so that it is ensured that no damage occurs. The fact is disadvantageous with this embodiment it is associated with high costs, that a relatively high unlatching torque is frequently required between the disk and the turntable and that, finally, the procedure of unlatching has to be detected electrically and has to be reported to the motor control for the purpose of stopping the motor.

It is furthermore known from the prior art to provide an overload coupling directly in the region of the motor shaft, which is admittedly more cost favorable than the solution described above, but is still associated with undesirably high costs. A serious disadvantage of an overload coupling in the motor area is furthermore the fact that, due to the cam course in the barrel cam, high torque loads only result in a low torque in the region of the motor at the turntable as the result of a blocking—at least at the start and at the end of a rotary cycle, said low torque often not sufficing to activate an overload coupling provided in the motor area. At the start and at the end of a rotary cycle, the actually effective region of the cam in the barrel cam namely only extends slightly obliquely to a peripheral line of the barrel cam so that a substantial gear reduction is effected here between the barrel cam and the turntable which then results in only low forces in the region of the motor shaft with large forces at the turntable. This then frequently has the effect—despite the provision of the overload coupling in the area of the motor shaft—of damage to workpieces, to the turntable or to the drive elements of the turntable.

### SUMMARY OF THE INVENTION

It is an object of the invention to develop a rotary indexing table of the initially named kind such that the effort to be undergone for the overload coupling is considerably reduced, with in particular a safe function of the overload coupling also being ensured in every moment of a rotary cycle.

This object is satisfied in accordance with the invention and in particular in that a sensor which generates an output signal and reacts to pressure and/or to tension is provided in the region of the barrel cam and/or in the region of a force transmission element and/or in the region of the drivers and in that, furthermore, an evaluation unit is provided for the output of a motor stop signal when the output signal exceeds a threshold value.

The surprisingly simple idea underlying the invention consequently consists, instead of a complex and expensive mechanical slip coupling, of only detecting whether, as a consequence of a blocking of the turntable, slight deformations of the force transmission elements or of the drivers occur in the area of the barrel cam, with the detection of a deformation of this type then resulting in a switching off of the motor driving the turntable. Sensors which can detect deformations of this type are available at favorable cost commercially as standard components and the evaluation of the signals supplied by such sensors can take place without problem within the framework of an electronic control system anyway present at or in the rotary indexing table. It is therefore only necessary for the realization of the principle in accordance with the invention to attach a favorably priced sensor to a suitable position of the rotary indexing table and to program the electronic control system anyway present such that an evaluation of the signal supplied by this sensor is possible. Consequently, in accordance with the invention, the economic effort to be made is substantially reduced with respect to the mechanical slip couplings known from the prior art.

The sensor used in accordance with the invention is preferably made as a strain gage or as a piezoelement. Slight deflections of support elements of the barrel cam or of the force transmission elements or also deformations occurring in the region of the drivers can, for example, be detected by means of a strain gage. It can, for example, be determined by means of a piezoelement whether the barrel cam is moving slightly in the direction of its axis of rotation, with the piezoelement, for example, being provided for this purpose between the end face end of the shaft of the barrel cam and an abutment arranged opposite this end. The use of strain gages or of piezoelements advantageously results in only very low costs, and the attachment of sensors of this type to a suitable region of the rotary indexing table is also possible without problem due to the small spatial dimensions of the sensors.

The invention can be used particularly advantageously when the force transmission elements provided between the motor and the barrel cam are made as reduction gears since in this case substantial differences arise between forced occurring at the barrel cam and at the motor.

It is of particular advantage if, for example, a strain gage is provided at a support element of the barrel cam and/or at the drivers. Alternatively, a pressure sensor, in particular a piezoelement, can be arranged opposite and end face end of the barrel cam.

With the last-named positionings of a strain gage or of a pressure sensor, it is namely ensured that a torque or a force in the region of the turntable or in the region of the drive elements directly coupled to it is actually measured without a reduction gear or the just active cam section of the barrel cam resulting in a reduction of the torques or forces to be measured. This represents a substantial advantage in particular at the start and at the end of a rotary cycle since due to the substantially sinusoidal acceleration development of the turntable in the named time sections even comparatively small forces in the region of the motor or of its drive shaft are sufficient to generate comparatively high forces in the region of the turntable drive. To avoid damage in the region of the turntable drive, it is therefore of substantial importance to measure the high forces possibly relevant to possible damage to the turntable drive directly in the region of the turntable drive and to neglect the comparatively low forces occurring in the region of the motor since these do not allow any statement on the forces actually acting on the turntable drive at the start and at the end of a rotary cycle. What is decisive for an emergency stop of the motor in accordance with the last-named, preferred embodiment are therefore only the forces or torques acting in the region of the turntable drive, i.e. the forces or torques acting at a support element of the barrel cam, at the drivers or at the end face end of the barrel cam.

When a strain gage is provided at a support plate of the barrel cam, it is particularly advantageous for the barrel cam to be supported in the respective support plate by means of a fixed bearing, in particular by means of two axial bearings and one radial bearing. In this case, a blocking of the turntable with a barrel cam continuing to rotate namely effects a force acting on the barrel can in the direction of its axis of rotation, said force being transmitted directly to the support plate due to the fixed bearing so that a slight deflection of the support plate results which can be detected by means of a strain gage.

The deflection effect of the support plate can be detected particularly easily by means of a strain gage if the support plate only has mutually spaced connection sections along its periphery via which it is sectionally connected to stationary parts of the rotary indexing table. The support plate is therefore preferably not coupled to stationary parts of the rotary indexing table in its total peripheral region, but only in the region of mutually spaced connection sections, which permits a certain movability of the support plate in the direction of the axis of rotation of the barrel cam. A deflection of the support plate is thus promoted when a force is exerted on it in the direction of the axis of rotation of the barrel cam. This deflection effect is in particular additionally amplified when the mutually spaced apart connection sections of the bearing plate are arranged distributed around the axis of rotation of the barrel cam.

A deflection of the bearing plate can then be detected particularly easily by means of a strain gage if it is attached to the support plate between two of the named connection sections.

Further preferred embodiments of the invention are explained in the dependent claims.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a partly sectioned plan view of a rotary indexing table in accordance with the invention with a removed turntable;

FIG. 2 is a plan view of a support plate being used with a rotary indexing table in accordance with FIG. 1 in the direction of the axis of rotation of the barrel cam;

FIG. 3 illustrates the speed development of a turntable of a rotary indexing table in accordance with FIGS. 1 and 2 during a rotary cycle;

FIG. 4 illustrates the acceleration development of the turntable belonging to FIG. 3; and

FIG. 5 illustrates the torque development at the turntable belonging to FIGS. 3 and 4.

### DETAILED DESCRIPTION OF THE PREFERRED EMBODIMENTS

The following description of the preferred embodiment is merely exemplary in nature and is in no way intended to limit the invention, its application, or uses.

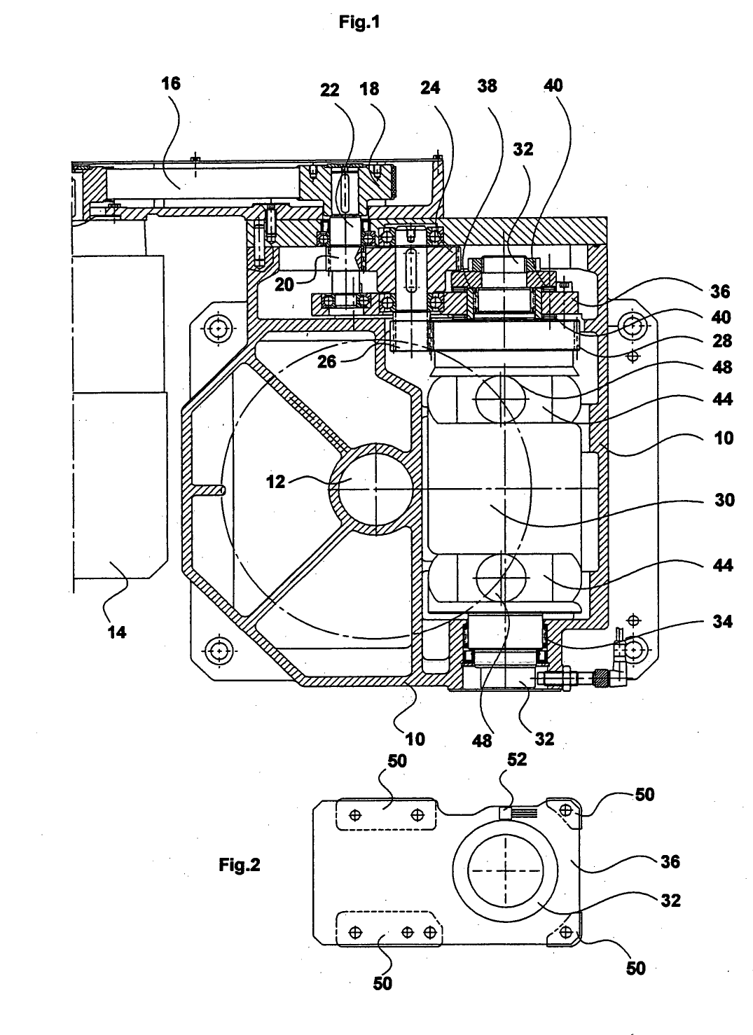

FIG. 1 shows—in plan view—a housing element 10 of a rotary indexing table which defines a receiver 12 for a shaft coupled to a turntable (not shown). A motor 14 is coupled to the housing element 10, is shown only sectionally and can rotationally drive a gear wheel 18 via a toothed belt 16, said gear wheel in turn being rotationally fixedly connected to a further gear wheel 20. The gear wheels 18, 20 accordingly have a common shaft 22 which is rotationally supported in those sections of the rotary indexing table which are arranged stationary with respect to the housing element 10.

The gear wheel 20 meshes with a larger gear wheel 24 which is rotationally fixedly connected to a further gear wheel 26 whose diameter is smaller than the diameter of the gear wheel 24. The gear wheels 24, 26 are also supported rotatably via a common shaft in support positions arranged stationary with respect to the housing element 10.

The gear wheel 26 meshes with an outer toothed arrangement 28 of a barrel cam 30, with the diameter of the outer toothed arrangement 28 being selected to be considerably larger than the diameter of the gear wheel 26.

A gear reduction results between the motor 14 and the barrel cam 30 due to the size ratios of the gear wheels 18, 20, 24, 26 and of the outer toothed arrangement 28.

The barrel cam 30 is rotatably supported around a shaft 32 in the housing element 10 or in parts fixedly connected thereto. In the end region of the shaft 32 remote from the outer toothed arrangement 28, this support consists of a movable bearing 34 which is made purely as a radial bearing and accordingly permits a certain movement of the shaft 32 in the direction of its longitudinal axis.

The other end of the shaft 32 is supported by means of a fixed bearing in a support plate 36 fixedly connected to the housing element 10, with this fixed bearing consisting of one radial bearing 38 and two axial bearings 40, 42. Due to the fixed bearing 38, 40, 42, the shaft 32 of the barrel cam 30 is fixed in the bearing plate 36 both in the direction of the axis of rotation of the barrel cam 30 and perpendicular thereto, which means that, when the barrel cam 30 moves in the direction of its axis of rotation, a force acting on the support plate is generated perpendicular to it.

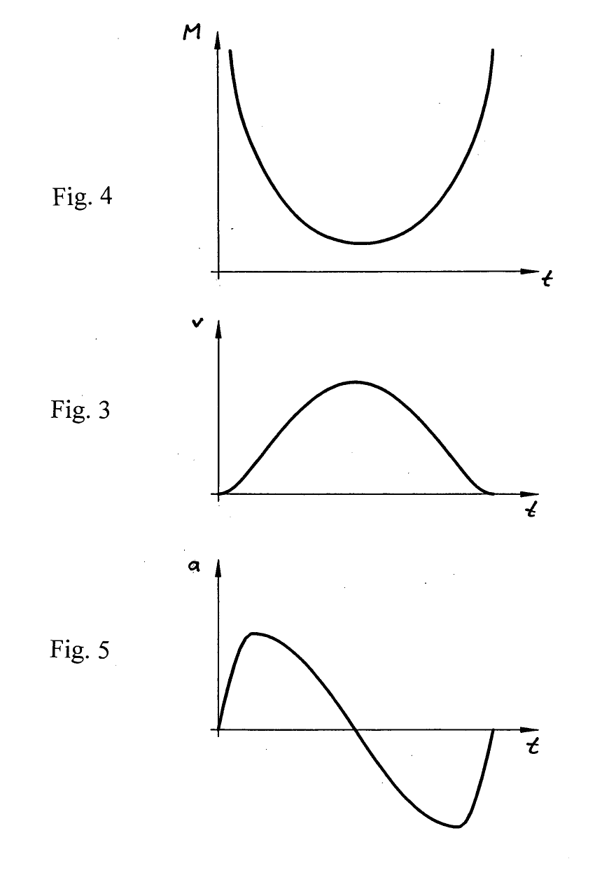

In a manner known from the prior art, the barrel cam 30 has substantially spirally peripheral recesses or cams 44 into which drivers 48 of a turntable (not shown) engage. In FIG. 1, only two drivers 48 are shown, with a turntable mounted on a rotary indexing table in accordance with FIG. 1 having a total of four or more drivers 48 equally distributed over its periphery. The recesses or cams 44 are made such that a rotation of the barrel cam 30 by 360° triggers one or more rotary cycles, while the turntable continues to rotate by a defined angle. On the execution of such a rotary cycle, the speed development of the turntable already explained above and described again in the following in connection with FIGS. 3 to 5 is achieved due to the cam development of the barrel cam 30.

FIG. 2 shows the support plate 36 in accordance with FIG. 1 with the shaft 32 of the barrel cam 30 supported therein. The support plate 36 has a total of four connection sections 50 which are arranged distributed substantially equally over the periphery of the shaft 32 and via which the bearing plate 36 is connected to stationary housing elements 10 of the rotary indexing table. These connection sections 50 are spaced apart from one another so that regions result which are arranged distributed over the periphery of the shaft 32 and which are not fixedly connected to housing elements 10 of the rotary indexing table and which thus permit a slight deflection of the bearing plate 36 in the direction perpendicular to the plane of the drawing of FIG. 2, i.e. in the direction of the axis of rotation of the shaft 32.

A strain gage 52 is provided in accordance with the invention above the shaft 32 between two adjacent connection sections 50 and is attached to the support plate 36 and is suitable to detect deflections of the support plate 36 in the direction of the axis of rotation of the shaft 32. The deflections which can be detected by commercial strain gages 52 can be relatively low and lie, for example, in the range of 1/1000 mm.

With an arrangement in accordance with FIGS. 1 and 2, the deflection of the support plate 36 on its being acted on by a force acting perpendicular to it is substantially proportional to the change in resistance of the strain gage 52 so that ultimately the electronically detectable change in resistance of the strain gage 52 is proportional to the axial force acting on the support plate 36.

FIG. 3 shows the speed development of a turntable coupled to a rotary indexing table in accordance with FIGS. 1 and 2 or of its drivers during a rotary cycle. This speed development has the shape of half a sine wave, which means that the rotary movement of a rotary cycle is initiated slowly at a low speed, whereupon an increase in the speed takes place up to a maximum so that a slow speed reduction down to the value of zero can again occur at the end of the rotary cycle.

The associated acceleration development in accordance with FIG. 4, which substantially has the form of a full sinus wave, shows that the acceleration at the start of a rotary cycle increases, starting from a value of zero, and drops back to the value of zero at the end of a rotary cycle.

The speed and acceleration developments shown in FIGS. 3 and 4 result—at a constant rotation speed of the motor 14—solely due to the shaping of the recesses or cams 44 in the barrel cam 30. At the start and at the end of a rotary cycle, the drivers 48 engage in those regions of the recesses or cams 44 which extend along a peripheral line, or only slightly obliquely to a peripheral line, of the barrel cam 30 for the generation of correspondingly low speeds, which means that ultimately, due to the cam developments present in these sections, an optionally additional gear reduction is achieved which has the result that very large torques or forces can act on the turntable or on its drive elements (drivers 48) which can result in a destruction of the turntable drive on a blocking of the turntable. The torque development present at the turntable and associated with FIGS. 3 and 4 is shown in FIG. 5 and shows that the torque is very high at the start and at the end of a rotary cycle.

In accordance with the invention, these high torques, however, at the same time effect a deflection of the support plate 36 which can be detected by means of the strain gage 52 so that in this case, a switching off of the motor 14 can take place in good time.

The description of the invention is merely exemplary in nature and, thus, variations that do not depart from the gist of the invention are intended to be within the scope of the invention. Such variations are not to be regarded as a departure from the spirit and scope of the invention.

### REFERENCE NUMBER LIST

10 housing element
12 shaft receiver
14 motor
16 toothed belt
18 gear wheel
20 gear wheel
22 shaft
24 gear wheel
26 gear wheel
28 outer toothed arrangement
30 barrel cam
32 shaft
34 radial bearing
36 support plate
38 radial bearing
40 axial bearing
42 axial bearing
44 recesses, cams
48 drivers
50 connection sections
52 strain gages

What is claimed is:

1. A rotary indexing table, comprising:
a turntable which has drivers (48) engaging into a barrel cam (30), with the turntable being rotatably drivable relative to a stationary center part via the barrel cam (30) which can in turn be acted on by a motor (14) via at least one force transmission element (16, 18, 20, 24, 26, 28) to make a rotary movement around its longitudinal axis,
a sensor (52) generating an output signal and reacting to pressure and/or tension, the sensor being provided in at least one of the region of the barrel cam (30), the region of a force transmission element (16, 18, 20, 24, 26, 28) and the region of the drivers (48), and
an evaluation unit is furthermore provided for the output of a motor stopping signal when the output signal exceeds a threshold value.

2. A rotary indexing table in accordance with claim 1, wherein the sensor is made as a strain gage (52) or piezoelement.

3. A rotary indexing table in accordance with claim 1, wherein the force transmission elements (16, 18, 20, 24, 26, 28) provided between the motor (14) and the barrel cam (30) are made as reduction gear transmissions.

4. A rotary indexing table in accordance with claim 1, wherein a strain gage (52) is provided at a support element (36) of the barrel cam (30) and/or at the drivers (48).

5. A rotary indexing table in accordance with claim 1, wherein a pressure sensor is provided opposite an end face end of the barrel cam (30).

6. A rotary indexing table in accordance with claim 1, wherein a strain gage (52) is provided at a support plate (36) of the barrel cam (30) in which the barrel cam (30) is supported by means of a fixed bearing (38, 40, 42), in particular by means of axial and radial bearings.

7. A rotary indexing table in accordance with claim 6, wherein the support plate (36) has mutually spaced connection sections (50) along its periphery via which it is sectionally connected to stationary parts (10) of the rotary indexing table.

8. A rotary indexing table in accordance with claim 7, wherein the mutually spaced apart connection sections (50) of the support plate (36) are arranged distributed around the axis of rotation of the barrel cam (30).

9. A rotary indexing table in accordance with claim 8, wherein the strain gage (52) is attached to the support plate (36) between two connection sections (50).
